(19) United States
(12) Patent Application Publication
(10) Pub. No.: US 2008/0034027 A1
(43) Pub. Date: Feb. 7, 2008

(54) Method for reducing round-off error in fixed-point arithmetic

(76) Inventors: Linfeng Guo, Cliffside Park, NJ (US); Yang Li, South Plainfield, NJ (US); Mark Sydorenko, New York, NY (US); Jun Tian, Edison, NJ (US); Hua Zheng, Secaucus, NJ (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 11/498,319

(22) Filed: Aug. 1, 2006

(51) Int. Cl. G06F 7/38

(52) U.S. Cl. 708/551

(57) ABSTRACT

Round-off error in fixed-point arithmetic is minimized by changing the magnitudes of two multipliers simultaneously. The dynamic range of an intermediate output is thus maximized to increase computation precision. A much smaller round-off error, caused by fixed-point arithmetic, thus results.

### CROSS REFERENCE TO RELATED APPLICATIONS

N/A

### STATEMENT REGARDING FEDERALLY SPONSORED RESEARCH OR DEVELOPMENT

N/A

### BACKGROUND OF THE INVENTION

In an N-bit fixed-point computation, every integer value is in the range of [−₂^{N-1},2^{N-1-}−1] If a given value exceeds 2^{N-1}, an overflow occurs; if a given value is below −2^{N-1}, an underflow occurs. Both overflow and underflow can be addressed by requiring that the input data be sufficiently small to avoid the possibility of overflow/underflow. To achieve these values, a single optimized multiplier is used. Thus, each multiplier in a fixed-point multiplication is either scaled up or scaled down by a power of the base. For example, the base is “2” in binary representation. After each multiplication, normalization of the intermediate output is performed.

As each value is represented by a finite-length sequence of binary digits, rounding (or truncation) introduces a computation error which can often be treated in terms of an additive noise. Such a computation error is referred as rounding error. The dynamic range of the intermediate output is limited using a single multiplier, resulting in a sub-optimal round-off error.

### BRIEF SUMMARY OF THE INVENTION

A method for reducing round-off error in fixed-point arithmetic is provided. The method described herein changes the magnitudes of two multipliers simultaneously; the dynamic range of an intermediate output is thus maximized to increase computation precision. This method has a much smaller round-off error, caused by fixed-point arithmetic, than prior approaches.

### BRIEF DESCRIPTION OF THE SEVERAL VIEWS OF THE DRAWINGS

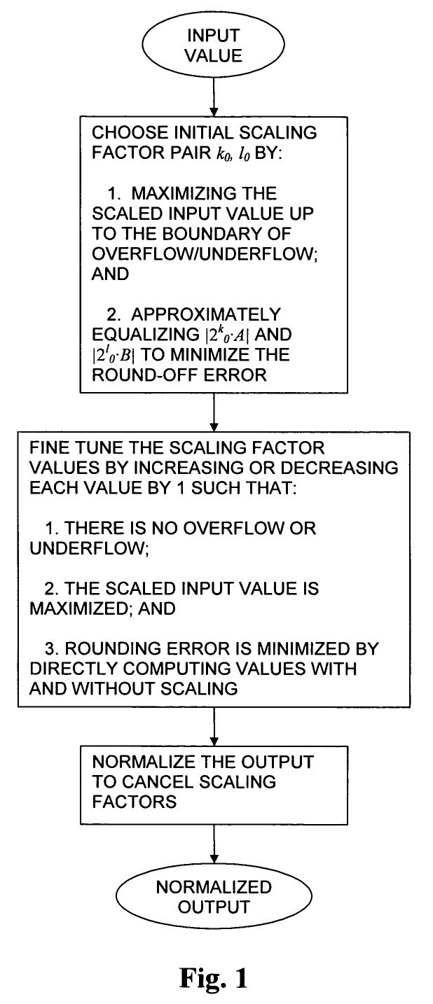

The invention will be more fully understood by reference to the following detailed description of the invention in conjunction with FIG. 1, which illustrates a method for reducing round-off error in fixed-point arithmetic, according to the presently disclosed invention.

### DETAILED DESCRIPTION OF THE INVENTION

When multiplying two numbers A and B in a fixed-point process, existing techniques select the number with the smaller magnitude and scale it up as much as possible. For example, if |A|>|B|, the existing technique would scale up the magnitude of B. To do this, the largest integer l is identified, such that

b=2^{l}·B+ε₂

where l is a scaling factor, b is the rounded integer after scaling,

$$- \frac{1}{2} \leq {ɛ}_{2} \leq \frac{1}{2} ,$$

and most importantly b and A*b are in the range of └−2^{N-1},2^{N-1}−1┘ (i.e., there is no underflow or overflow). Then,

$$A \cdot B = A \cdot \frac{b - {ɛ}_{2}}{{2}^{l}} = \frac{A \cdot b}{{2}^{l}} - \frac{A \cdot {ɛ}_{2}}{{2}^{l}}$$

whereby the rounding error is

$$\frac{A \cdot {ɛ}_{2}}{{2}^{l}} .$$

The disadvantage of this known technique is that the scaling range is very limited, especially when one of the multipliers has a large magnitude, which leads to large rounding errors.

In contrast, the presently disclosed technique, or process, provides an optimal setting for scaling factors such that the rounding error is minimized. An analytic formula which minimizes the rounding error is now illustrated. Assume a and b are scaled values of A and B, i.e.,

a=2^{k}·A+ε₁, and

b=2^{l}·B+ε₂

where k,l are scaling factors (when k>0, it is scaling up; when k<0, it is scaling down), k+l is fixed, a,b are rounded integers after scaling, and

$$- \frac{1}{2} \leq {ɛ}_{1} , {ɛ}_{2} \leq \frac{1}{2} .$$

First,

$$A \cdot B = \frac{a - {ɛ}_{1}}{{2}^{k}} \cdot \frac{b - {ɛ}_{2}}{{2}^{l}}$$

$$A \cdot B = \frac{a \cdot b}{{2}^{k + l}} + \frac{- a {ɛ}_{2} - b {ɛ}_{1} + {ɛ}_{1} {ɛ}_{2}}{{2}^{k + I}}$$

whereby the rounding error is

$$\frac{- a {ɛ}_{2} - b {ɛ}_{1} + {ɛ}_{1} {ɛ}_{2}}{{2}^{k + I}} ,$$

which is approximately equal to

$$\frac{- a {ɛ}_{2} - b {ɛ}_{1}}{{2}^{k + 1}} .$$

### Since k+l is fixed, rounding error is minimized by minimizing −aε₂−bε₁. As

$$\vert - a {ɛ}_{2} - b {ɛ}_{1} \vert \leq \frac{\vert a \vert + \vert b \vert}{2}$$

and a·b is in the fixed range of 2^{k+l}A·B, it follows that when |a| and |b| are closer in value, then

$$\frac{\vert a \vert + \vert b \vert}{2}$$

gets smaller, and so does |−aε₂−bε₁|.

Thus, one would choose k and l, such that after scaling, the scaled values |a| and |b| are in the same range └2ⁿ,2ⁿ⁺¹), for some integer n, then the rounding error from a·b is minimized.

With the above theoretical analysis, to derive appropriate settings which minimize the rounding error, an initial scaling factor pair (k₀,l₀) is defined, such that:

1. The input value is scaled up as much as possible (up to the boundary of overflow/underflow); and

2. After scaling, the two values |2^{k}^{₀}·A| and |2^{l}^{₀}·B| are as close to each other as possible.

Next, the scaling factor pair is finely tuned via increasing or decreasing each value by one such that:

1. There is no overflow/underflow;

2. The value is scaled up as much as possible; and

3. The rounding error is minimized.

The rounding error is computed by directly computing (either addition or multiplication) the values with and without scaling. Usually after three or four fine tunings, the appropriate settings which minimize the rounding error will be derived, i.e., when the rounding error could not be further reduced.

After all appropriate settings which minimize the rounding error for each multiplication are derived, the final output will be normalized to cancel out all scaling factors.

The foregoing method for reducing round-off error in fixed-point arithmetic can be implemented by a wide variety of computing hardware and software, including specially programmed general purpose computing systems, custom-designed computing hardware including application specific integrated circuits (ASICs), etc.

These and other embodiments of the invention illustrated above are intended by way of example and should not be viewed as limiting the scope of the disclosure or of the claims. The actual scope of the invention is to be limited solely by the scope and spirit of the following claims.

What is claimed is:

1. A method for reducing round-off error in a fixed-point arithmetic operation involving two operands A, B, the fixed-point arithmetic operation having predefined overflow and underflow boundaries for the scaled operands, operand A having a scaled value a defined by 2^{k}·A+ε₁ and operand B having a scaled value b defined by 2^{l}·B+ε₂, where (k,l) are scaling factors and
$$- \frac{1}{2} \leq {ɛ}_{1} , {ɛ}_{2} \leq \frac{1}{2} ,$$
the method comprising:
selecting an initial scaling factor pair (k₀,l₀) whereby each scaled operand value a, b is proximate to or substantially equal to one of the overflow or underflow boundaries without exceeding said one boundary and whereby the values of |2^{k}^{₀}·A| and |2^{l}^{₀}·B| are as close as possible for all values of (k₀,l₀); and
fine-tuning the initial scaling factor pair values by simultaneously adding one to a first of the scaling factors and subtracting one from a second of the scaling factors until the following conditions are simultaneously met:
1. neither of the scaled values exceed the overflow or underflow boundaries,
2. each of the scaled values cannot be increased without exceeding one of the overflow or underflow boundaries, and
3. a rounding error for each operand is minimized.

2. The method of claim 1, where the rounding error for each operand is determined by comparing each operand to the scaled value for a given scaling factor value.

3. The method of claim 1, wherein the rounding error for each operand is minimized when the absolute value of each of the scaled values, |a| and |b|, are both in the range └2ⁿ,2ⁿ⁺¹) for some integer n.
